(19) United States
(12) Patent Application Publication
(10) Pub. No.: US 2005/0193016 A1
(43) Pub. Date: Sep. 1, 2005

(54) Generation of a media content database by correlating repeating media content in media streams

(76) Inventors: Nicholas Seet, Los Angeles, CA (US); Vivien Zapf, Los Angeles, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/061,770

(22) Filed: Feb. 17, 2005

Related U.S. Application Data
(60) Provisional application No. 60/545,681, filed on Feb. 17, 2004.

(51) Int. Cl. G06F 7/00

(52) U.S. Cl. 707/104.1

(57) ABSTRACT

A media content database is created and maintained by comparing the media items from two related media streams. Segments of media items from the streams are sampled and stored. Samples from one stream are matched against samples from the other stream to identify any repeating content in the streams. A reviewer observes the matched samples representing the repeating content and provides identifying meta-data for that content. The identified media content is then added to the media content database, where it can be used at a later time in an application that requires media content recognition.

### CROSS REFERENCE TO RELATED APPLICATIONS

This application claims the benefit of U.S. Provisional Application No. 60/545,681, filed Feb. 17, 2004, which is incorporated by reference in its entirety.

### BACKGROUND

1. Field of the Invention

This invention relates generally to media content recognition, and in particular to the creation and maintenance of a media content database for use in connection with a media content recognition system.

2. Background of the Invention

A number of systems have been created for automatically identifying media content. In a process sometimes referred to as audio fingerprinting, for example, characteristic information is extracted from an audio signal. This characteristic information works as a fingerprint to provide unique information about the audio signal. The fingerprint can be compared against a set of known reference fingerprints to find a match and thus identify the audio signal. Not limited to audio signals only, fingerprinting techniques have enabled a number of solutions to technical problems that require the automated identification of various types of media content.

For example, a computing device may be configured to receive streaming media content for which it is desired to identify particular media items contained in the stream. Using a media fingerprinting technique, the computing device can identify media items in the stream by extracting one or more fingerprints from the streaming media. The computing device then compares the fingerprints extracted from the stream against a set of reference fingerprints in a canonical database of fingerprints for known media items. Such a system could be used to audit Internet radio stations or other non-digital, traditional media providers for compliance with licenses and/or royalties. In another application, a fingerprinting system implemented on a personal computer could be used to identify shared content and prevent the unauthorized use of protected works (e.g., by filtering out unlicensed media) while allowing the sharing of licensed media and other copyrighted material between users.

These and other applications of media identification systems are based on the principle of comparing an extracted fingerprint to a set of reference fingerprints to identify the media. A common element of these systems, therefore, is a database of reference fingerprints against which identifications are attempted. This database preferably contains fingerprints for each of the media items that represent possible matches for the media content to be identified.

Generating the media content database presents a major challenge for anyone implementing an audio or media identification system. The fingerprints usually must be generated, as the owners of media content will generally not have fingerprints of their media. Therefore, to create the media content database usually requires access to the source media so that reference fingerprints can be extracted for each of the media items. Due to licensing issues, operational issues, cost issues, and other sources of media owner discomfort, gaining access to the source media to fingerprint it may be unfeasible. In addition, maintaining the media content database requires periodic addition of new media content, which presents similar problems.

An example of a system that monitors advertisements played on a radio or television broadcast (or cable or satellite systems) illustrates some of these problems. To be able to identify when a particular advertisement is playing, existing methods would involve obtaining the high-quality original advertisement from the advertiser, extracting a fingerprint from the advertisement, and inserting the fingerprint and advertisement information into a media content database. Only once this is performed for an advertisement can the system identify when that advertisement is played. A typical TV station may have over one thousand ads from which it can select its lineup. One can appreciate that in a system that must monitor a large number of advertisements, creating the media content database could be prohibitively time-consuming and costly.

Moreover, the existing process presents many operational issues. An advertiser that wished to monitor its competitors' advertising strategies would have a difficult time obtaining the advertisements from the competitors for that purpose. Even if the advertisers were willing to provide their advertisements beforehand, the advertisements may be provided in many different formats (e.g., cassette tapes, beta, VHS, MPEG, and many others). Conversion of the advertisements into a consistent format would be time consuming and possibly unreliable, and there would be no guarantee that the content that was provided was in fact what would be broadcast by the radio or television station.

It is therefore apparent that existing solutions require labor-intensive processes (such as the manual marking of ad start and stop times), require content owner participation (sending their content to be stored in the database), and/or are significantly slower and less comprehensive due to these processes. It is desirable to improve upon existing content identification systems to avoid the problems inherent with the creation of the media content database. Specifically, it is desirable to allow generation of fingerprint or other characteristic data in the media content database without the limitations presented by existing solutions.

### SUMMARY OF THE INVENTION

To address the problem of existing content acquisition solutions, embodiments of the invention attempt to match content sampled from a media stream with content sampled from another media stream (which may be a different time period of the same media stream). For example, audio items from a radio broadcast can be matched against audio items from a previous period of the same broadcast. In this way, the radio broadcast itself is used as the source of data to avoid having to extract the characteristic information from a number of master recordings for each audio item.

Acquiring the media content directly from an incoming media stream (e.g., a broadcast signal) removes the need to acquire that content—usually a large number of separate items—directly from each of the media content owners. Significant operational and competitive advantages are realized when the content owner need not be involved. This process will also tend to improve the accuracy of the matches because the signal quality is matched between source and test audio. The matched media items from this process can later be tagged and added to a master canonical database using minimal human interaction. This method of creating and maintaining the media content database is largely automated because it removes many of the labor-intensive steps of existing solutions.

In one embodiment, a media content database is created and maintained by comparing the media items from two related media streams, where content may be repeated between the streams. The related streams may be different time periods of the same broadcast media stream. Segments of media items from the streams are sampled and stored. Samples from one stream are matched against samples from the other stream to identify any repeating content in the streams. A reviewer observes the matched samples representing the repeating content and provides identifying meta-data for that content. The identified media content is then added to the media content database, where it can be used at a later time in an application that requires media content recognition.

### BRIEF DESCRIPTION OF THE DRAWINGS

FIG. 1 is a schematic diagram of a system for creating and maintaining a media content database, in accordance with an embodiment of the invention.

FIG. 2 is a flow diagram of a process for creating and maintaining a media content database, in accordance with an embodiment of the invention.

FIG. 3 illustrates a process in which a set of samples is matched against another set of samples from a previous period, in accordance with an embodiment of the invention.

FIG. 4 illustrates a process in which a match for an unmatched sample is inferred based on its temporal location to other matched samples, in accordance with an embodiment of the invention.

### DETAILED DESCRIPTION OF THE PREFERRED EMBODIMENTS

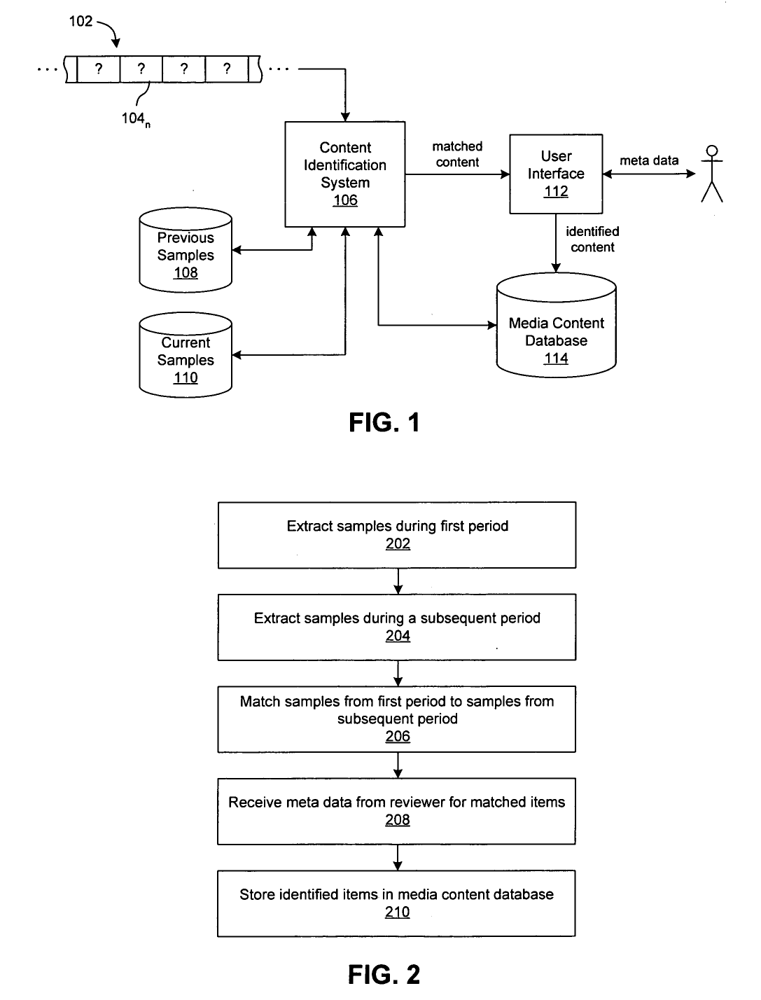

Illustrated in FIG. 1 is one embodiment of a system that can be used to create and maintain a media content database 114 using an incoming media data stream 102. A content identification system 106 is configured to receive a media stream 102, which comprises one or more (typically unknown) media items 104ₙ. As explained in more detail below, the content identification system 106 samples portions of the media items 104ₙ in the media stream 102 to extract characteristic information from them and then stores that information in the previous samples database 108 and/or the current samples database 110. The content identification system 106 attempts to match samples in the current samples database 108 with samples in the previous samples database 110. Matched samples are made accessible by a reviewer through a user interface 112, which allows the reviewer to observe the matched media content and provide identifying meta-data for that content. The identified media content is then added to the media content database 114, where it can be used by the content identification system 106 at a later time in an application that requires media content recognition.

In one embodiment, for each of a plurality of media items, the media content database 114 associates meta-data about the media item with characteristic information that preferably uniquely identifies the media item. Structured in this way, the database 114 can be used in a number of media content recognition applications. In a typical example, a matching algorithm is used to locate a test sample in the database 114 by matching characteristic information about the test sample to a set of characteristic information stored in the database 114. If there is a match, the test sample has been identified, and the meta-data associated with the matching characteristic information is thus associated for the test sample as well.

In an example application of this technology in the radio broadcast field, the media content database 114 stores a set of fingerprints, each fingerprint including uniquely identifying information about an advertisement, a song, or another audio item. A content recognition system samples a radio broadcast and extracts a fingerprint from a segment of the radio broadcast. Using a matching algorithm, the system attempts to locate a match within the media content database 114 to this extracted fingerprint. If a match is found, the system determines that the portion of the radio broadcast from which the fingerprint was taken to be the audio item associated with the matching fingerprint. In this way, the content recognition system has automatically identified the audio item that was played on the radio broadcast during the time the sampled segment was being played.

It can therefore be appreciated that media content recognition schemes need a sufficiently large set of reference content in the media content database 114 SO that a match can be made. A test sample that does not have a matching record in the media content database 114 cannot be identified using that database 114. A larger database 114 thus enables the identification of more content. But extracting characteristic information from each of a large number of (typically high-quality) original master recordings would be time-consuming and possibly unfeasible. Addressing this problem, embodiments of the invention use an incoming media stream itself to create the database 114.

FIG. 2 illustrates a general process for creating and maintaining a media content database 114, such as the one illustrated in FIG. 1, in accordance with an embodiment of the invention. Based on a received media stream 102, a set of samples is extracted 202 during a first period. The samples each correspond to a time period in the stream 102, and therefore to one of the unknown media items 104ₙ in the stream 102. Preferably, each sample includes characteristic information about a portion of the incoming media stream 102 as well as a marker (e.g., a timestamp) that identifies the location within the stream 102. A second set of samples is then extracted 204 during a subsequent period from the same received media stream.

With the two sets of samples extracted, the system attempts to match 206 at least some of the samples in the second set of samples to the first set of samples. The matching may be made according to the extracted characteristic information for each sample, where a match occurs between two samples if their characteristic information differs within a predetermined tolerance. Any matched content in the second set of samples is then provided to a reviewer, from which meta-data are received 208. Preferably, the meta-data describe identifying information about media items in the stream that are associated with the matched content. The meta-data are then stored 210 in the media content database 114, along with the characteristic information of their associated samples, for use in a media content recognition application.

This general process can be applied in an example radio broadcast application, in which the content of a radio broadcast from a previous period is used to match against the contents of the same radio broadcast from a later period. A first a period (e.g., a few hours, or a day) of the uninterrupted broadcast signal is stored in a database capable of performing matches against this content. A subsequent period of the broadcast signal is then matched against the database containing the first period. If the broadcast signal is the same or is otherwise logically related (i.e., and operator assumes similar content), it is expected that much of the content from the second period would match much of the content from the first period. The areas that match (i.e., the repeating content) are then extracted and flagged for a human reviewer to review and identify, which can then be added to and used by a conventional media content database. In this way, a database of audio content is obtained without having to request and extract fingerprints from each possibly audio item on the radio broadcast.

As explained with respect to FIG. 1, the incoming media stream 102 contains a number of media items 104n. The media stream 102 may arrive from any suitable source and may comprise a radio broadcast, a television broadcast, an Internet media broadcast, a series of digital files received over a network or from a storage device, or any of a number of sources from which a computing device can receive media content. The type of media items 104n that compose the stream 102 may vary depending on the type of media stream 102. For example, if the media stream 102 is a radio broadcast, the media items 104ₙ may comprise a song, an advertisement, a segment of a radio show, or any other type of audio content typical of such broadcasts. Alternatively, if the media stream 102 is a video broadcast, each media item may comprise a television show or segment, an advertisement, or any other type of video or audio/video content typical of such broadcasts. If the stream 102 is received over a computer network or from a data storage device, the media items 104n may comprise computer files, computer software programs, or other types of media content that may be found in electronic storage. Accordingly, the invention is not limited to any particular type of media type or content used in the examples described herein, but rather can be used in a number of media applications.

To obtain samples of the media stream 102, the content identification system 106 performs an algorithm on a sample segment of the incoming stream 102. The algorithm used and the segment sampled may vary depending on the application. In one embodiment of a radio or television monitoring application, the broadcast during a previous period (e.g., a day) from a particular station (or genre or group of similar stations) is sampled. In the sampling process, the stream 102 is segmented into a plurality of segments, and each segment is fingerprinted to obtain characteristic information about that segment. The characteristic information (i.e., the fingerprint) and a marker (such as a timestamp) are associated with each other. In one embodiment for monitoring advertisements, the recorded audio is segmented into small increments of less than about 4 seconds in duration. This duration is chosen for this application because four-second samples are short enough to occur three to seven times during a standard 15 to 30 second broadcast commercial.

Any number of suitable sampling algorithms can be used to obtain characteristic information about a segment of the stream 102. Different schemes may apply different segmenting to the stream 102 and different fingerprinting algorithms to those segments. Various embodiments of systems for extracting a characteristic fingerprint, or “thumbprint,” from a data signal are described in U.S. application Ser. No. 10/132,091, filed Apr. 24, 2002, which is incorporated by reference in its entirety. The data signal may be any type of signal, including streaming digitized audio or obtained from static files. Also described are a database of reference thumbprints and methods for searching the database to identify a test thumbprint within the database.

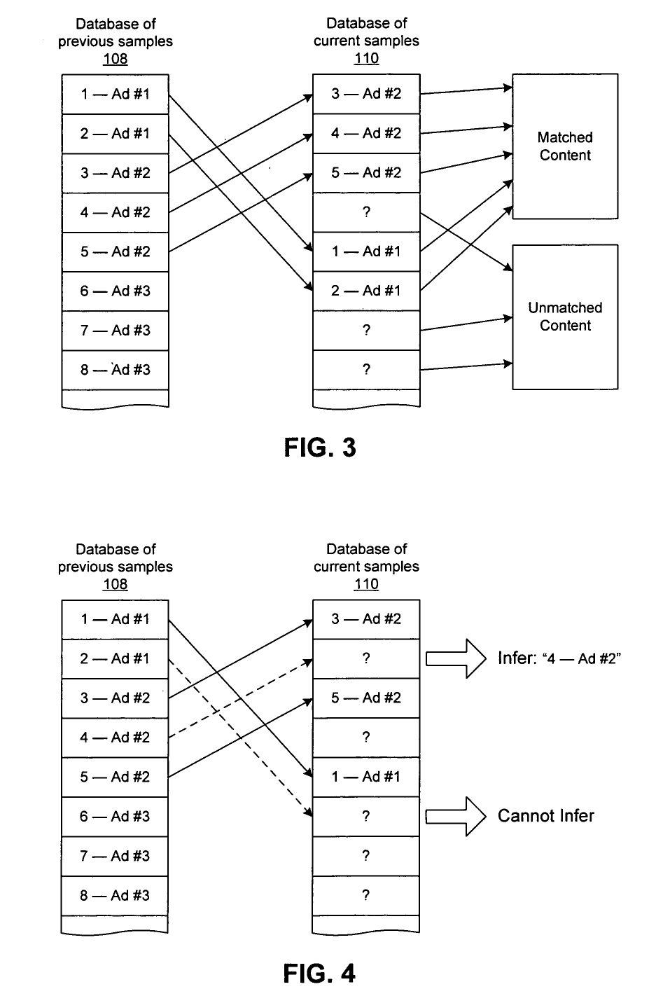

Once a set of samples are extracted and stored on the previous samples database 108, the system 106 attempts to match in the current samples database 110 against samples in the previous samples database 108. FIG. 3 illustrates one embodiment of this matching process. As illustrated, the previous samples database 108 includes a plurality of samples that are arbitrarily numbered, in this example starting at 1. Although the system does not initially know the identity of each sample, the identity is shown in the figure for explanation purposes. As shown, samples 1 and 2 are of a first advertisement, samples 3 through 5 are of a second advertisement, and samples 6 through 8 are of a third advertisement.

For another stream 102 (e.g., during a subsequent period), samples are obtained and then stored in the current samples database 110. Matches are then attempted for samples in the current samples database 110 against those in the previous samples database 108. In the example shown in FIG. 3, the first three samples match samples 3 through 5 from the previous samples database 108, and the fifth and sixth samples match the first two samples from the previous samples database 108. For the matched content, an identifier (or identifiers if multiple-matches are found) and a timestamp or other marker for the samples are recorded. Once the attempted sampling in completed, any unmatched content is moved from the current samples database 110 to the previous samples database 108 for use in a next cycle of the method.

Because the samples are typically obtained in noisy conditions, they may not match exactly even where they are of the same content. Therefore, whether two samples match may be defined as differing by less than a predefined tolerance, which is set by an operator depending on the tolerance for false positives and false negatives. U.S. application Ser. No. 10/830,962, filed Apr. 22, 2004, which is incorporated by reference in its entirety, describes a number of embodiments of schemes for matching test data (such as audio signals) to data within a database. The matching methods described therein enable the efficient fuzzy matching of data sampled from a noisy environment to samples within a large repository; therefore, they is well suited for matching media content sampled in noisy or imperfect environments.

Optionally, the system 106 may infer additional matches. A matching inference may be made for some samples based on their position in a media stream 102 relative to other matched samples. Specifically, if a match is not made for a particular sample, its surrounding samples may still be in the correct sequence and timing so that a match for the unmatched sample can be made. FIG. 4 illustrates a process in which a match for an unmatched sample is inferred based on its temporal location with respect to other matched samples. In this example, the second sample in the current samples database 110 was not matched to any sample in the previous samples database. However, because its previous sample was matched to sample 3 and its following sample was matched to sample 5, the system can infer that the second sample matches sample 4 of the previous samples database. The temporal consistency of the bounding samples allows one to infer that they are of the same media item 104ₙ (in this case, an advertisement labeled #2); therefore, the middle sample is also of the same media item 104n. Continuing the example, the sixth sample in the current samples database 110 also was not matched, but a matching for this sample is not inferred because it is not bounded by matched samples that correspond to the same media item 104n.

As mentioned, the matched samples are provided to a user interface 112 to allow a human reviewer to identify their content and provide meta-data for the content. To make this task easier by reducing the number of items that must be reviewed, the samples are preferably grouped if it is possible to determine that one or more of the samples are part of the same media item 104n in the stream 102. Accordingly, the content identification system 106 performs a post-processing on the list of matched samples and attempts to group the content by examining relative alignment of identified sequential samples against the previous day samples in the database. This process uses both the inter-sample spacing and the timestamp from where the audio was matched to determine which sequence of samples (and where in those samples) constitutes a complete media item 104n (e.g., a whole advertisement, song, or media program). In this way, fewer and more complete items are provided to the reviewer in an automated fashion, thus making it easier to review the content as well as minimizing the number of items to review.

Depending on the application, any number of heuristics may be developed to group the matched samples based on the content of the media that is expected to be repeated—and thus matched by the system. In one embodiment, the grouping of content also takes into account the length of the group that would result from the grouping as well as an expected length for content that the system is intended to capture. For example, in a system designed to capture radio broadcast advertisements, the expected length of the advertisements may be between 10 and 60 seconds. Accordingly, one embodiment of such a system automatically throws out or disregards any series of matches that is longer than 60 seconds or less than 10 seconds, since these sets are probably not advertisements. This may create a limitation for the system, however, since advertisements that are played back-to-back in each stream may be thrown out because their combination (which repeated) was longer than the expected range. In such a case, the advertisements would have to be played separately in the media stream for this embodiment of the system to be able to capture each advertisement.

Once a matching relationship is established between the previous period's database and a number of the current period's samples, it can be asserted that the portions of the previous period database that were matched are repeated content such as like advertisements, promotions, songs, or the like. This repeated content is presented to a reviewer so that the reviewer may observe the content and add associate meta-data with it. Using the user interface 112, a human reviewer can manually observe just the series of matched samples (or grouped samples). Based on what the reviewer observes, the reviewer can add identifying meta-data to the series of samples (e.g., advertisement identifier, artist, title information, or the like). This manual process needs to be done only once for each unique piece of content, since it will be stored in the media content database 114 for retrieval as desired at a later time.

The items to be reviewed may be restricted to fit certain size characteristics (i.e., approximately 60 seconds), so they can be quickly auditioned and tagged in the user interface 112. In one embodiment, the user interface 112 presents groups of matched samples to the user so that the reviewer can listen to or otherwise observe as much of the sequence of samples and the reviewer likes. This allows the reviewer to enter the content's meta-data and then skip to the next sequence to be reviewed. The user interface 112 may be available as a software application or as an Internet based website.

The identified content is stored in the media content database 114 along with the meta-data associated with it. The identified content may be stored in the media content database 114 in any of a variety of forms. In one embodiment, the identified content is stored as the fingerprint (or other type of characteristic information) extracted during the process described above. Alternatively, the identified content may be stored as the segment or media item itself (in which case a new fingerprint may have to be generated for the media if a matching into the database 114 is desired). If there are memory limitations with the database 114, the identified content may be stored as a link to an external source that allows retrieval of the media, its fingerprint, or some other information that can be used in a media content recognition application. Identified content is preferably left in the database 114 indefinitely or until a set expiration date is reached since the content's last use.

As the processes described herein may require a great deal of database activity, efforts are preferably taken to reduce the search times involved. Such efforts may include loading the database into a RAM drive or dividing the active portion of the database into day-parts that correspond to the well-known listening patterns of the medium (e.g., morning-drive time for radio, and prime-time for television). Additionally, if the database contains duplicate entries, a post-processing algorithm preferably includes the ability to group matches into sets that correspond to the duplicate sample sets. To do this, the underlying fingerprinting software should return all matches, not just the first match.

Embodiments of the invention need not be limited to the matching of samples to previous samples of the same media stream. For example, embodiments might attempt to match samples against samples from a different stream that is likely to have similar or overlapping content. Embodiments may also attempt to match samples against samples taken simultaneously or later in time than the samples to be matched. Accordingly, some alternative embodiments of the invention may not require that samples from a media stream be matched against samples for that stream taken during an earlier time period.

Although several embodiments of the invention are described in the context of creating a media content database for advertising items in radio or television broadcasts, embodiments of the invention can be applied to a number of different media types. Different signal types and distribution mechanisms are applicable provided that they are tracking some form of repeating content. Some examples would include:
creating a database of music from the radio;
creating a database of music from an Internet stream;
creating a database of video programs from TV/cable/satellite;
creating a database of video from an internet stream;
creating a database of faces from a closed circuit TV system;
creating a database of files being exchanged over a network;
creating a database of voices from a recorder; and
creating a database of radio patterns from a radio signal receiver.

From these examples, it should be evident that any signal that contains repeating content over any broadcast medium can benefit from the procedure described herein.

A number of embodiments are described above with reference to audio content; however, it should be understood that various embodiments of the media content database system could be used with any other type of media content or other types of media items. As used herein, media items and media data may include information used to represent a media or multimedia content, such as all or part of an audio and/or video file, a data stream having media content, or a transmission of media content. Media content may include one or a combination of audio (including music, radio broadcasts, recordings, advertisements, etc.), video (including movies, video clips, television broadcasts, advertisements, etc.), software (including video games, multimedia programs, graphics software), and pictures; however, this listing is not exhaustive. Furthermore, media data, media items, and media content include anything that itself comprises media content, in whole or in part. Media data, media items, and media content can be encoded using any encoding technology, and they may also be encrypted to protect their content using an encryption algorithm or any other suitable encryption technique.

Any of the steps, operations, or processes described herein can be performed or implemented with one or more software modules or hardware modules, alone or in combination with other devices. It should further be understood that any portions of the system described in terms of hardware elements may be implemented with software, and that software elements may be implemented with hardware, such as hard-coded into a dedicated circuit. For example, code for performing the methods can be embedded in a hardware device, such as an MP3 player, for example in an ASIC or other custom circuitry. This combines the benefits of the invention with the capabilities of many different devices. In a hardware embodiment, portions or all of the methods can be performed by analog circuitry. In one embodiment, a software module is implemented with a computer program product comprising a computer-readable medium containing computer program code, which can be executed by a computer processor for performing any or all of the steps, operations, or processes described herein.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

1. A method for creating and maintaining a media content database, the method comprising:
sampling a first media stream to obtain a first set of samples, each sample including characteristic information for a segment of the first media stream;
sampling a second media stream to obtain a second set of samples, each sample including characteristic information for a segment of the second media stream;
matching at least some of the second set of samples against the first set of samples;
receiving identifying information for the matched samples; and
storing the matched samples and their corresponding identifying information in the media content database.

2. The method of claim 1, wherein the first media stream is an earlier portion of a media broadcast and the second media stream is a later portion of the media broadcast.

3. The method of claim 1, wherein the first and second media streams are audio broadcasts.

4. The method of claim 1, wherein at least some of the matched samples are of advertisements.

5. The method of claim 1, further comprising:
combining a group of matched samples into a single unit representing a single media item in the second media stream; and
presenting the group of matched samples together for receiving identifying information therefor.

6. The method of claim 1, further comprising:
inferring a match for an unmatched sample of the second set of samples based on the temporal location of the unmatched sample with respect to other matched samples in the second set.

7. The method of claim 1, wherein receiving identifying information is performed using a web-based user interface.

8. The method of claim 1, wherein the received identifying information for a sample comprises meta-data for a media item associated with the sample.

9. A method for generating entries for a media content database, the method comprising:
receiving a first media stream;
receiving a second media stream;
matching at least some portions of the second media stream to the first media stream to determine repeating content between the streams; and
presenting the repeating content to a reviewer for identification.

10. The method of claim 9, further comprising:
receiving identifying information about the repeating content from a reviewer.

11. The method of claim 10, further comprising:
creating a set of entries for the media content database, each entry including a portion of the repeating content and the identifying information received from the reviewer.

12. The method of claim 9, wherein the first and second media streams comprise a media broadcast, and the repeating content includes advertisements transmitted in the radio broadcast.

13. The method of claim 9, wherein the matching comprises:
dividing each of the first and second media streams into a plurality of segments;
generating fingerprints of the segments of each media stream;
determining whether at least some of the fingerprints of the segments of the first media stream are within a predetermined tolerance of any fingerprints of the segments of the second media stream.

14. The method of claim 9, wherein the repeating content is presented to a reviewer over a web-based interface.

15. A computer program product for creating and maintaining a media content database, the computer program product comprising a computer-readable medium containing computer program code for performing the operations:
sampling a first media stream to obtain a first set of samples, each sample including characteristic information for a segment of the first media stream;
sampling a second media stream to obtain a second set of samples, each sample including characteristic information for a segment of the second media stream;
matching at least some of the second set of samples against the first set of samples;
receiving identifying information for the matched samples; and
storing the matched samples and their corresponding identifying information in the media content database.

16. The computer program product of claim 15, wherein the first media stream is an earlier portion of a media broadcast and the second media stream is a later portion of the media broadcast.

17. The computer program product of claim 15, wherein the first and second media streams are audio broadcasts.

18. The computer program product of claim 15, wherein at least some of the matched samples are of advertisements.

19. The computer program product of claim 15, the computer-readable medium further containing computer program code for performing the operations:
combining a group of matched samples into a single unit representing a single media item in the second media stream; and
presenting the group of matched samples together for receiving identifying information therefor.

20. The computer program product of claim 15, the computer-readable medium further containing computer program code for performing the operations:
inferring a match for an unmatched sample of the second set of samples based on the temporal location of the unmatched sample with respect to other matched samples in the second set.

21. The computer program product of claim 15, wherein receiving identifying information is performed using a web-based user interface.

22. The computer program product of claim 15, wherein the received identifying information for a sample comprises meta-data for a media item associated with the sample.
